(19) United States
(12) Patent Application Publication
(10) Pub. No.: US 2012/0026377 A1
(43) Pub. Date: Feb. 2, 2012

(54) ELECTRONIC MIRROR AND METHOD

(76) Inventor: Steven D. Waite, Pueblo West, CO (US)

(21) Appl. No.: 13/017,252

(22) Filed: Jan. 31, 2011

Related U.S. Application Data
(63) Continuation-in-part of application No. 12/715,697, filed on Mar. 2, 2010.

(51) Int. Cl. H04N 5/222

(52) U.S. Cl. 348/333.01; 348/E05.022

(57) ABSTRACT

The present invention is directed to an electronic mirror designed to replace a pocket or purse mirror. The electronic mirror has a handheld housing. A processor is in the housing. The housing includes a first electronic image sensor attached to the processor. A second electronic image sensor is detachably attached to the housing. The housing has an electronic display. The second electronic image sensor has a wireless connection with the housing. This allows the user to move the second electronic image sensor so they can see the back of their head. It also allows them to monitor a child. The electronic mirror includes a selector for determining which of the two image sensors is being displayed on the electronic display.

### RELATED APPLICATIONS

The present invention is a continuation-in-part of patent application Ser. No. 12/715,697, filed on Mar. 2, 2010, entitled “Electronic Mirror” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

It is quite common for people to carry pocket mirrors in their purse to check their hair and makeup. Often these pocket mirrors are in a case that may contain a light or makeup. While these mirrors are convenient they have several limitations. For instance, a pocket mirror is not useful for looking at the hair on the back of the head. In addition, a pocket mirror has no way to magnify an image.

Thus there exists a need for a mirror that allows the user to check the back of their head and to magnify areas that are hard to see.

### BRIEF SUMMARY OF INVENTION

An electronic mirror that overcomes these and other problems has a housing. A processor is in the housing. The housing includes a first electronic image sensor attached to the processor. A second electronic image sensor is detachably attached to the housing. The housing has an electronic display. In one embodiment, the second electronic image sensor has a wireless connection with the housing. This allows the user to move the second electronic image sensor so they can see the back of their head. It also allows them to monitor a child. The electronic mirror includes a selector for determining which of the two image sensors is being displayed on the electronic display.

This electronic mirror fits in a women's purse and allows the owner to move the image sensor around to see the side and back of their head. It also includes a freeze frame feature and a zoom feature.

### BRIEF DESCRIPTION OF THE SEVERAL VIEWS OF THE DRAWINGS

FIG. 1 is a top right front perspective view of an electronic mirror in accordance with one embodiment of the invention;

FIG. 2 is a top left front perspective view of an electronic mirror in accordance with one embodiment of the invention;

FIG. 3 is a back view of an electronic mirror in accordance with one embodiment of the invention;

FIG. 4 is a side perspective view of an electronic mirror in accordance with one embodiment of the invention;

FIG. 5 is an exploded perspective view of an electronic mirror in accordance with one embodiment of the invention;

FIG. 6 is a top right front perspective view of an electronic mirror with the image sensor extended in accordance with one embodiment of the invention; and

FIG. 7 is a front image of an electronic mirror in accordance with one embodiment of the invention;

FIG. 8 is block diagram of an electronic mirror in accordance with one embodiment of the invention; and

FIG. 9 is a flow chart of the steps used in a method of operating an electronic mirror in accordance with one embodiment of the invention.

### DETAILED DESCRIPTION OF THE INVENTION

The present invention is directed to an electronic mirror designed to replace a pocket or purse mirror. The electronic mirror has a housing with an electronic display. The electronic mirror includes a processor driving the display. An image sensor is connected to the processor by an electronic cord. The electronic cord is held in place by a retraction mechanism. In use the owner can pull out the image sensor to view the back, top and sides of their head. In one embodiment, the electronic mirror includes a freeze frame feature and zoom feature. The electronic mirror solves the limitations associated with a standard handheld mirror.

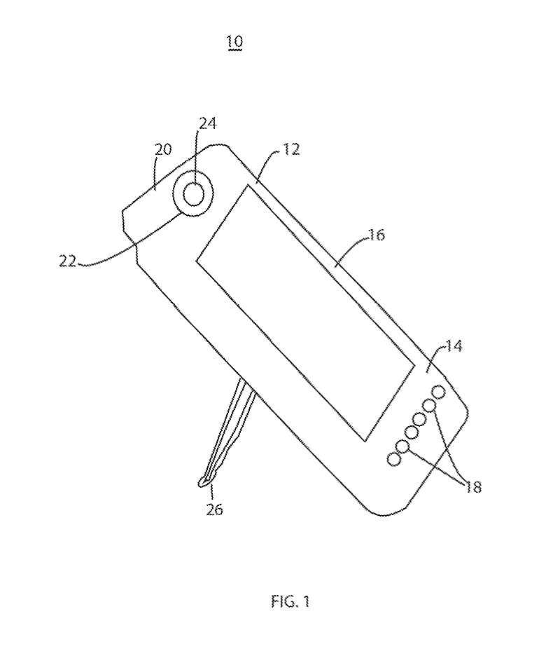

FIG. 1 is a top right front perspective view of an electronic mirror 10 in accordance with one embodiment of the invention. The electronic mirror 10 has an essentially rectangular housing 12. The housing 12 has a front face 14 that has an electronic display 16 and a plurality of buttons 18. An electronic image sensor 20 fits in a notch 22 in the housing 12. The electronic image sensor 20 has a fixed lens 24. In one embodiment, the electronic image sensor has a multi-focal lens 24. A stand 26 is pivotally attached to the housing 12. In another embodiment, the electronic mirror includes a light as part of the image sensor. This allows the owner to use the mirror in low light situation.

Note that the same reference numerals will be used for the same elements through out the description.

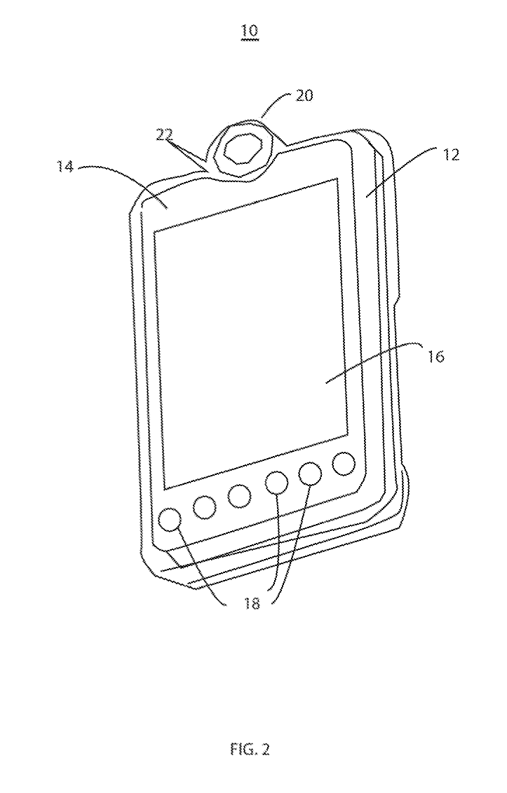

FIG. 2 is a top left front perspective view of an electronic mirror 10 in accordance with one embodiment of the invention. The electronic mirror 10 has a housing 12 with a front face 14 that has an electronic screen 16 that is a color screen in one embodiment. A plurality of buttons 18 are also located on the front face 14 of the housing 12. An image sensor 20 fits into a slot 22 of the housing 12.

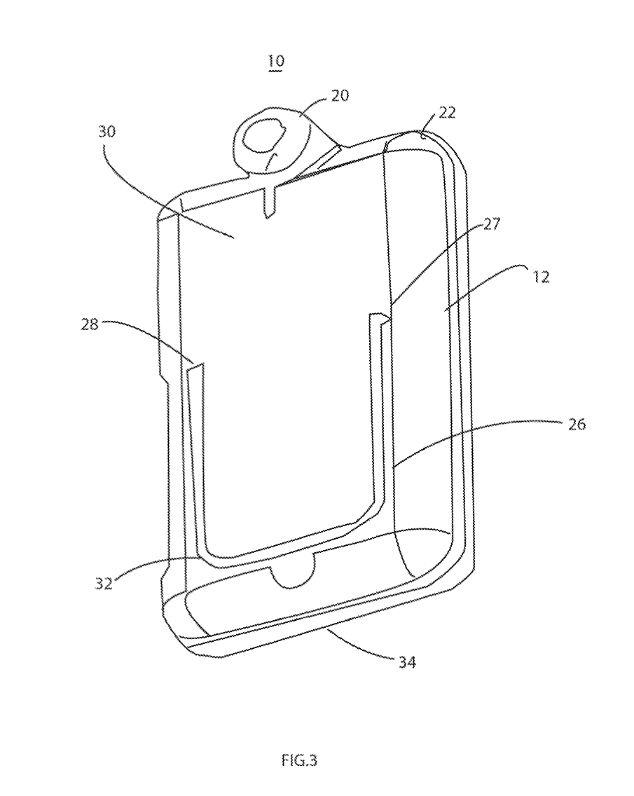

FIG. 3 is a back view of an electronic mirror 10 in accordance with one embodiment of the invention. In this view there is shown a stand 26 that is pivotally attached 28 to the housing 12. In one embodiment, the stand 26 is a metal wire and the ends fit is slots that allows the stand 26 to pivot. When the stand 26 is folded against the back face 30 it fits into a groove 32 so that it is flush with the back face 30. A finger slot 34 is provided so the user can easily pull the stand 26 out.

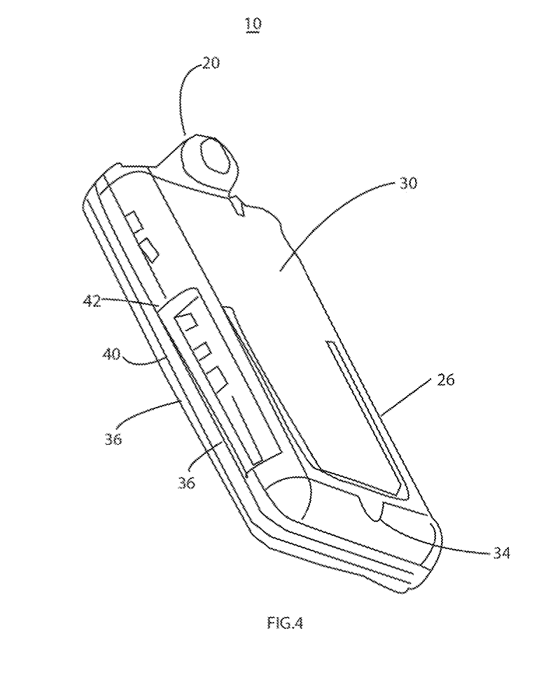

FIG. 4 is a side perspective view of an electronic mirror 10 in accordance with one embodiment of the invention. This view shows that in one embodiment, the electronic mirror 10 includes an SD (Secure Digital) memory card slot 36. A USB (Universal Serial Bus) port 38 is provided. Video input and output ports 40, 42 may also be provided.

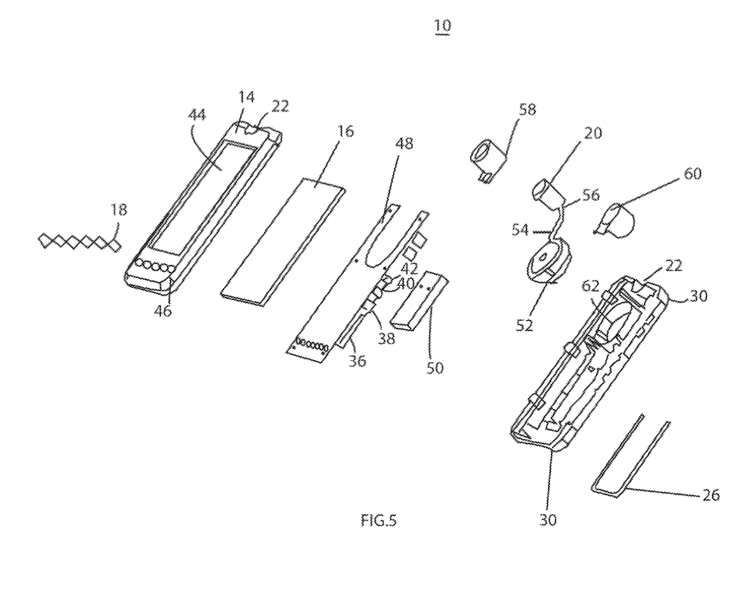

FIG. 5 is an exploded perspective view of an electronic mirror 10 in accordance with one embodiment of the invention. The electronic mirror 10 has a front face 14 that includes an opening 44 for a display 16 and a plurality of holes 46 for buttons 18. The front face 14 has a cutout or slot 22. An electronic circuit board 48 fits inside the housing 12. The electronic circuit 48 may include a processor, a SD memory card slot 36, a USB port 38, and video input and output ports 40, 42. A battery 50 is inside the housing and attaches to the electronic circuit 48. A retraction mechanism 52 is used for retracting an electronic cord 54. A first end of the electronic cord 54 is attached to the retraction mechanism 52 and is in electrical communication with the electronic circuit 48. The second end 56 of the electronic cord 54 is attached to the electronic image sensor 20. The image sensor 20 is encased in a cylindrical housing 58, 60. The back face 30 of the electronic mirror 10 has a circular chamber 62 for holding the retraction mechanism 52. The stand 26 is shown separate from the back face 30.

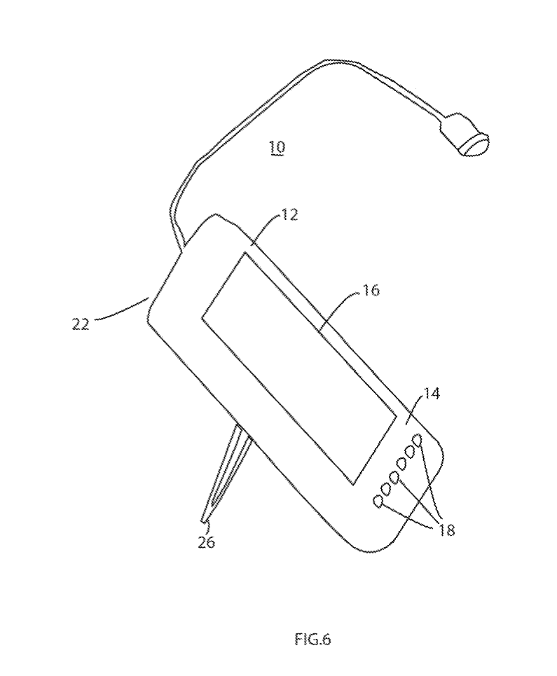

In operation the user turns on the electronic mirror 10 by pushing a button 18 and then pulls the image sensor 20 out of slot 22 as seen in FIG. 6. The user can then move the image sensor around to see the back of their head, top of their head or sides of their head. If they want to freeze the image, they press a button 18 that causes the processor to implement a freeze frame function. The user can also digitally zoom in on the image by pressing a button 18 that causes the processor to implement a digital zoom feature. In one embodiment, the physical lens is a fixed lens. When the user is done with the electronic mirror 10, the retraction mechanism 52 retracts the image sensor back into slot 22. The user can then turn off the mirror or in one embodiment the mirror may turn off after predetermined period of time of no use.

In one embodiment, the electronic mirror 10 may include a digital picture frame functionality. The SD card can hold a number of photos which allows the electronic mirror to then display the photos.

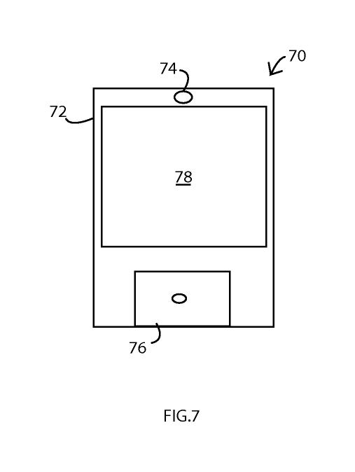

FIG. 7 is a front image of an electronic mirror 70 in accordance with one embodiment of the invention. The electronic mirror 70 has a housing 72 that fits easily in a person's hand. The housing 72 has a first electronic image sensor 74 built in. A second electronic image sensor 76 is detachably attached to the housing 72 and communicates with the housing a wireless interface. This allows the second electronic image sensor 76 to be moved up to one hundred feet away from the housing 72 in one embodiment. The user can then position the second electronic image sensor 76 anywhere they desire, including being able to see the back of their head. The second electronic image sensor 76 snap fits to the housing 72 in one embodiment. The housing 72 includes an electronic screen 78 that is a touch screen in one embodiment of the invention. The images from the first and second electronic image sensors 74 & 76 are displayed on the screen 78 for the user to see.

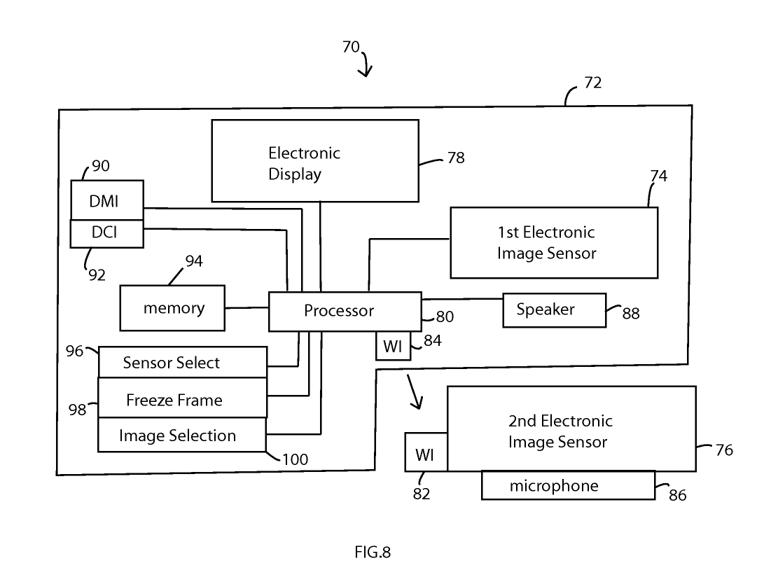

FIG. 8 is block diagram of an electronic mirror 70 in accordance with one embodiment of the invention. The mirror 70 has a processor 80 that receives images from the first electronic image sensor 74 and the second electronic image sensor 76. The second electronic image sensor 76 communicates with the processor 80 through a wireless interface 82, 84. In one embodiment, a microphone 86 is associated with the second electronic image sensor 77 and transmits sounds to the processor 80. The electronic display 78 receives and displays images from the processor 80. A speaker 88 is attached to the processor 80 in one embodiment. The processor 80 is coupled to a digital memory interface 90, which is a SD (Secure Digital) card slot in one embodiment. A digital communication interface 92 is coupled to the processor 80, which is a USB (Universal Service Bus) in one embodiment. Memory 94 is associated with the processor 80. The processor 80 includes an electronic image sensor selection 96. This determines whether the image displayed on display 78 is from the first electronic image sensor 74 or from the second electronic image sensor 76 or from memory 94 or a memory card in the DMI 90. The freeze frame function 98 freezes an image from the first or second electronic image sensor 74, 76 and it is displayed on the display 78. Otherwise the images from the sensors 74 & 76 are updated continuously. An image selection function 100 allows the user to select images that have been stored in memory 94 or are stored on an external memory device connected to the DMI 90 or the DCI 92. The DCI 92 allows images to be added to memory 94 or transferred from memory 94 to a computer. The speaker 88 and microphone 86 allow the user to use the second electronic image sensor as a baby monitor.

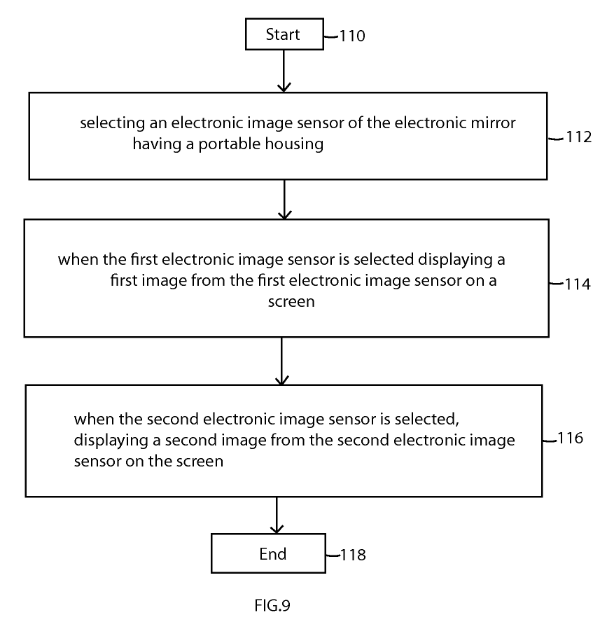

FIG. 9 is a flow chart of the steps used in a method of operating an electronic mirror in accordance with one embodiment of the invention. The process starts, step 110, by selecting an electronic image sensor of the electronic mirror having a portable housing at step 112. When the first electronic image sensor is selected, displaying a first image from the first electronic image sensor on a screen at step 114. When the second electronic image sensor is selected at step 116, displaying a second image from the second electronic image sensor on the screen, which ends the process at step 118. In one embodiment, the second image is wirelessly transmitted from the second electronic image sensor to the screen. In another embodiment, the second electronic image sensor is moved to a desired location, such as a position to view the back of the user's head. In one embodiment, a freeze frame function is selected. A user may review a plurality of images stored on the electronic mirror in one embodiment. In another embodiment, an image may be transferred to a computer. A memory card may be inserted into the electronic memory to store or download images.

Thus there has been described an electronic mirror that allows the user to check the back of their head and to magnify areas that are hard to see. The electronic mirror is convenient and fits inside a purse or can carried in a pocket by itself.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An electronic mirror comprising:
a housing;
a processor in the housing
a first electronic image sensor on the housing;
a second electronic image sensor detachably attached to the housing; and
an electronic display on the housing.

2. The electronic mirror of claim 1, wherein the second electronic image sensor includes a wireless transmitter and the housing has a wireless receiver.

3. The electronic mirror of claim 1, wherein the electronic display is a touch screen.

4. The electronic mirror of claim 1, further including a camera selection function in the processor.

5. The electronic mirror of claim 1, wherein the processor includes a freeze frame function.

6. The electronic mirror of claim 1, further including a memory attached to the housing.

7. The electronic mirror of claim 6, wherein the processor includes a image selection function.

8. A method of operating an electronic mirror, comprising the steps of:
selecting an electronic image sensor of the electronic mirror having a portable housing;
when the first electronic image sensor is selected, displaying a first image from the first electronic image sensor on a screen; and
when the second electronic image sensor is selected, displaying a second image from the second electronic image sensor on the screen.

9. The method of claim 8, wherein the step of selecting the second electronic image sensor includes wirelessly transmitting the second image from the second electronic image sensor to the screen.

10. The method of claim 9, further including the step of moving the second electronic image sensor to a desired location.

11. The method of claim 8, further including the step of selecting a freeze frame function.

12. The method of claim 8, further including the step of reviewing a plurality of images.

13. The method of claim 11, further including the step of transferring the first image from the electronic mirror to a computer.

14. The method of claim 8, further including the step of inserting a memory card into the electronic memory.

15. An electronic mirror comprising:
a handheld housing;
a processor in the handheld housing
a plurality of electronic image sensors in communication with the processor;
an electronic display in the handheld housing; and
a selector for selecting one of the plurality of electronic image sensors in communication with the processor.

16. The electronic mirror of claim 15, wherein one of the plurality of electronic image sensors is physically attached to the handheld housing.

17. The electronic mirror of claim 16, wherein one of the plurality of electronic image sensors is includes a wireless communication link to the handheld housing.

18. The electronic mirror of claim 17, further including a digital memory interface in the handheld housing.

19. The electronic mirror of claim 18, further including a digital communication interface in the handheld housing.

20. The electronic mirror of claim 19, wherein the electronic display is a touch screen.
